(19) United States
(12) Patent Application Publication
(10) Pub. No.: US 2018/0217943 A1
(43) Pub. Date: Aug. 2, 2018

(54) Automatic Encryption of Failing Drives

(71) Applicant: Lenovo (Singapore) Pte. Ltd., Singapore (SG)

(72) Inventors: John S. Crowe, Durham, NC (US); Gary D. Cudak, Wake Forest, NC (US); Jennifer J. Lee-Baron, Morrisville, NC (US); Nathan J. Peterson, Oxford, NC (US); Amy L. Rose, Chapel Hill, NC (US); Bryan L. Young, Tualatin, OR (US)

(21) Appl. No.: 15/419,034

(22) Filed: Jan. 30, 2017

(51) Int. Cl. G06F 12/14; G06F 21/62

(52) U.S. Cl. CPC G06F 12/1408; G06F 2212/1052; G06F 21/6218

(57) ABSTRACT

An approach is disclosed that detects that a unencrypted nonvolatile storage device, such as a hard disk drive, is failing. When the detection is made, the approach encrypts files stored on the nonvolatile storage device.

### BACKGROUND

An effective way to stop criminals stealing data from secondhand computers and discarded hard drives is to destroy the hard drive. Even though people think they have wiped data from machines before they sell them or throw them away, the files remain on the hard drives. These discarded hard drives and can contain vital information such as bank details and other personal data sufficient for identity theft. Criminals can recover the using recovery software that is widely available. The problem lies in the way that hard drives store information. An index file on the hard drive, written by the computer processor, stores and updates a listing of where on the physical hard drive each file is located. When the user “deletes” a file on the system, the index entry is removed—but the file itself, with its data, remains on the hard drive. Sophisticated recovery tools are able to find the files themselves and recover that data—which can be incredibly detailed, including a user's browsing and email history, as well as other sensitive and confidential information of the user.

### SUMMARY

An approach is disclosed that detects that a unencrypted nonvolatile storage device, such as a hard disk drive, is failing. When the detection is made, the approach encrypts files stored on the nonvolatile storage device.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages will become apparent in the non-limiting detailed description set forth below.

### BRIEF DESCRIPTION OF THE DRAWINGS

This disclosure may be better understood by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a diagram depicting a system that automatically encrypts a failing unencrypted hard drive;

FIG. 4 is a flowchart showing steps performed to monitor a hard drive for failures to determine if the hard drive should be encrypted to secure sensitive data; and

FIG. 5 is a flowchart showing steps performed to encrypt data on a previously unencrypted hard drive.

### DETAILED DESCRIPTION

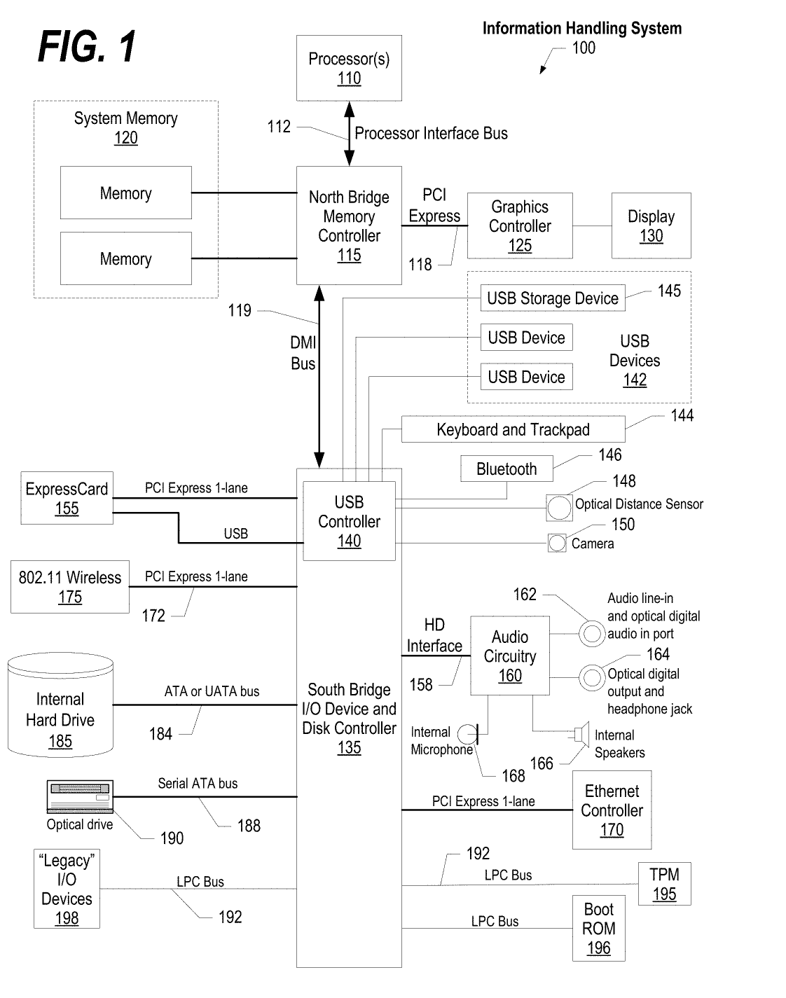

An approach is depicted in FIGS. 1-6 that detects wireless signals to engage security system awareness. Using detected wireless signals, this approach makes an alarm system smarter. The approach involves storing a user's personal wireless fingerprints in a security system via a router or other means. This would include all of the system's Wi-Fi signals, Bluetooth, NFC, etc. When the system detects a wireless signal that doesn't belong to a member of the household, the approach can modify parameters of the security system. For example, the approach could turn on the security system if it was turned off, turn on the security cameras and/or permanently store the camera feeds, etc. for future reference.

The following examples are provided for further illustration of the approach depicted herein. In a first example, a user's wireless fingerprints are stored as know users to the system. Any other wireless fingerprints signals would set parameters on the security system (e.g., turn system ON, turn cameras ON, etc.). In a second example, a stranger's wireless fingerprints are logged as well and then added to the list of know users, as needed. Visiting friends, relatives, etc. can be added to the list. In a third example involving a populated area, the approach can limit the range of detection to not pick up neighbors' houses, etc. The approach can also go through a learning mode if necessary to detect constant wireless signals from a neighbor's house. Security system parameters could then be triggered also by an increasing signal strength of a neighbor's device in case the neighbors are walking to the user's house rather than just staying at their house. A fourth example, set in a rural area, the approach does not have to perform any learning that might otherwise be performed in a populated area.

The following are few use cases that further illustrate the approach described herein. In a first use case, someone comes to the user's house in the middle of the day, in which case the user's security system could arm itself the user had forgotten to arm the system when the user left the house to go to work. The approach could also send the user an alert that the system detected unknown wireless signals proximate to the user's home along with the types of signals and potentially a signal strength. As wireless technology advances, the signal strengths and data associated will provide better distance metrics. In a second use case, if an unknown person comes to the user's house, it could turn on the user's security cameras even before the motion sensors detect anyone near the premises. In addition, the approch could send the user an alert of an outside presence near the user's home. In a third use case, if a family member visits the user's home, the security system can detect the visit and the user can opt to add the family member's wireless fingerprint to a list of know users along with the identification of the family member being added to the list.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The detailed description has been presented for purposes of illustration, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. As used herein, a computer readable storage medium does not include a computer readable signal medium.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

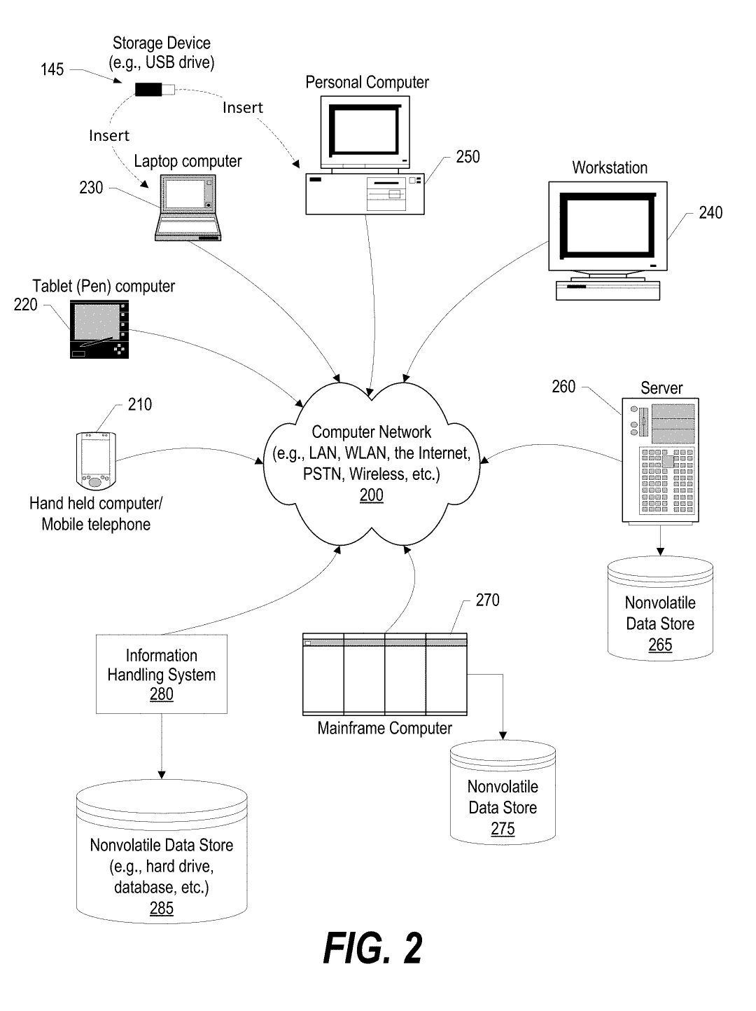

The following detailed description will generally follow the summary, as set forth above, further explaining and expanding the definitions of the various aspects and embodiments as necessary. To this end, this detailed description first sets forth a computing environment in FIG. 1 that is suitable to implement the software and/or hardware techniques associated with the disclosure. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include digital camera 150, optical distance sensor 148, keyboard and trackpad 144, and Bluetooth device 146, which provides for wireless personal area networks (PANs). Optical distance sensor 148 can detect the distance from a device to various objects, such as users of the system, while digital camera 150 can be used to capture images of objects, such as users of the system, to enable recognition software, such as facial recognition software, to identify the users of the system. USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

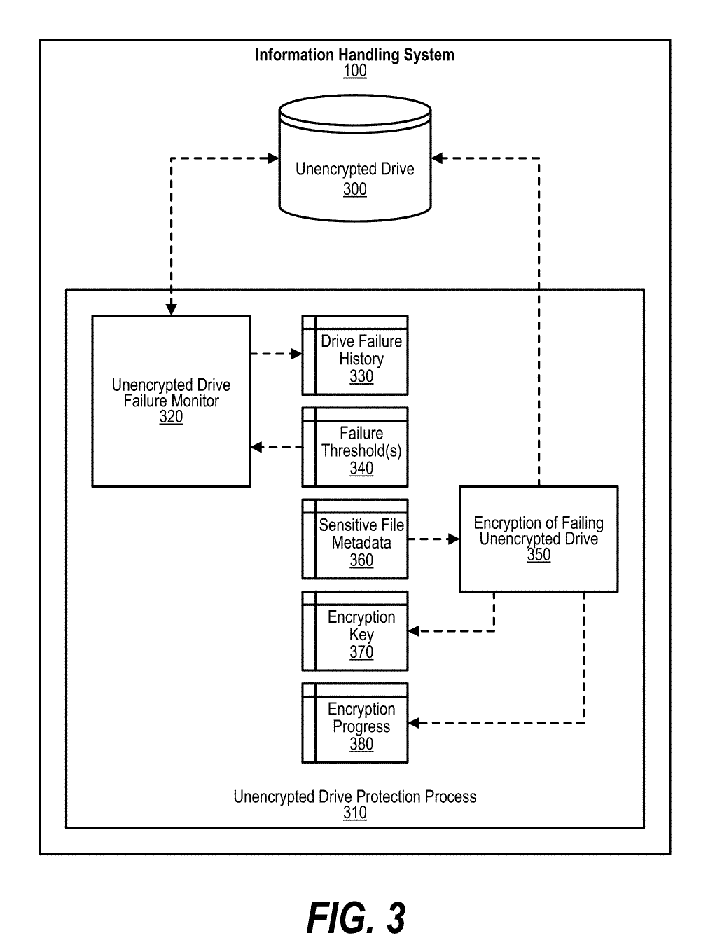

FIG. 3 is a diagram depicting a system that automatically encrypts a failing unencrypted hard drive. Information handling system 100 includes unencrypted nonvolatile storage device 300 and drive protection process 310. Drive protection process includes drive failure monitor process 320 that monitors the nonvolatile storage device and determines, or predicts, when the unencrypted nonvolatile storage device is about to fail.

Unencrypted drive failure monitor process 320 maintains drive failure history that is stored in data store 330 and compares the health of the drive, as reflected in the drive failure history, with failure thresholds that are stored in data store 340. Various failure metrics can be logged and analyzed, such as with S.M.A.R.T. (Self-Monitoring, Analysis, and Reporting Technology). These failures can include metrics and analysis of bad sectors on the nonvolatile storage device, stiction identification of the drive head starting to become stuck to the drive platter, circuit failure analysis of the electronic circuitry operating the drive, bearing and motor failure, and other mechanical failures.

When process 320 detects that nonvolatile storage device 300 is starting to fail, then encryption process 350 is performed. In one embodiment, process 350 utilizes sensitive file metadata that is maintained in data store 360 to ascertain which files are most sensitive. For example, the user or default settings may indicate that certain user files, such as user created documents, spreadsheets, presentation files, and the like are more sensitive than other files, such as executables and data files utilized by off-the-shelf application programs. In this embodiment, the sensitive file metadata is used to prioritize the order of files stored on the unencrypted nonvolatile storage device that are encrypted to protect the files. Encryption process 350 generates an encryption key 370 that is stored in another nonvolatile storage location, such as a nonvolatile memory, rather than storing the encryption key on nonvolatile storage device 300. The encryption key is also stored in a different location than nonvolatile storage device 300 so that if the nonvolatile storage device is discarded, after the files have been encrypted, a malicious user would be unable to retrieve the encryption key and, therefore, would be unable to decrypt the files encrypted and stored on nonvolatile storage device 300.

Process 350 further keeps track of the encryption progress so that the user can be informed of which files that were encrypted before a total failure of nonvolatile storage device 300 occurs. The encryption process is stored in data store 380. In this manner, the user can be informed of whether all sensitive data was encrypted before the nonvolatile storage device failed. If all sensitive data, such as the user's personal information, financial information, passwords, etc., was encrypted before the drive failed, then the user can dispose of the failed nonvolatile storage device without fear that a malicious user could recover sensitive data from the drive as all such sensitive data was encrypted. On the other hand, if all sensitive data was not able to be encrypted before the drive failed, the user could take steps, such as crushing or burning the nonvolatile storage device so that sensitive data stored on the drive would be unable to be recovered due to the complete destruction of the physical nonvolatile storage device.

The data stores utilized by drive protection process 310 (data stores 330, 340, 360, 370, and 380). are stored on a nonvolatile storage location other than nonvolatile storage device 300. Another nonvolatile storage location is used to stored the data stores so that the data can be utilized even when nonvolatile storage device 300 has failed and cannot be accessed by the system.

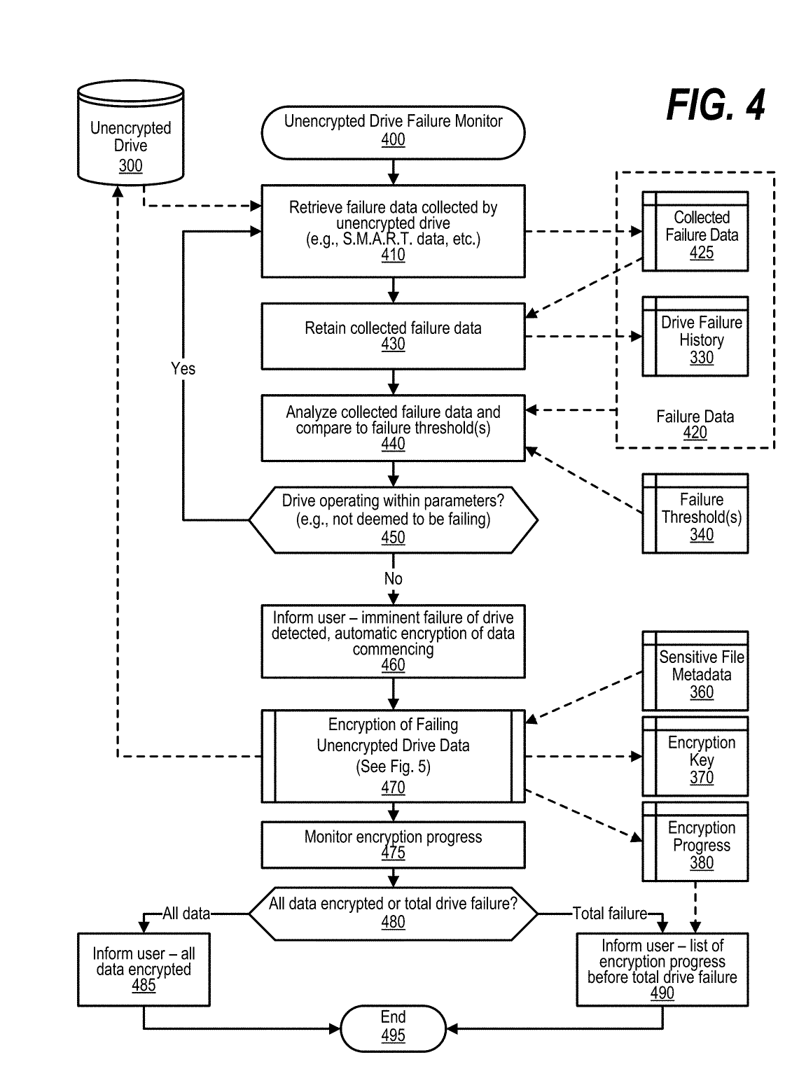

FIG. 4 is a flowchart showing steps performed to monitor a hard drive for failures to determine if the hard drive should be encrypted to secure sensitive data. FIG. 4 processing commences at 400 and shows the steps taken by a process that performs an unencrypted drive failure monitor process. At step 410, the process retrieves failure data collected by unencrypted nonvolatile storage device (e.g., using S.M.A.R.T. data gathered at the drive, etc.). The collected failure data is stored in data store 425. At step 430, the process retains the failure data collected at step 410 in historical drive failure data that is stored in data store 330. At step 440, the process analyzes the collected failure data and compares the collected failure data to failure thresholds that are retrieved from data store 340. Based on the comparison, he process determines whether the nonvolatile storage device is operating within established parameters (decision 450). If the nonvolatile storage device is operating within established parameters, then decision 450 branches to the ‘yes’ branch which loops back to step 410 to continue gathering failure data pertaining to the nonvolatile storage device. This looping continues until the nonvolatile storage device is no longer operating within parameters (is starting to fail), at which point decision 450 branches to the ‘no’ branch exiting the loop.

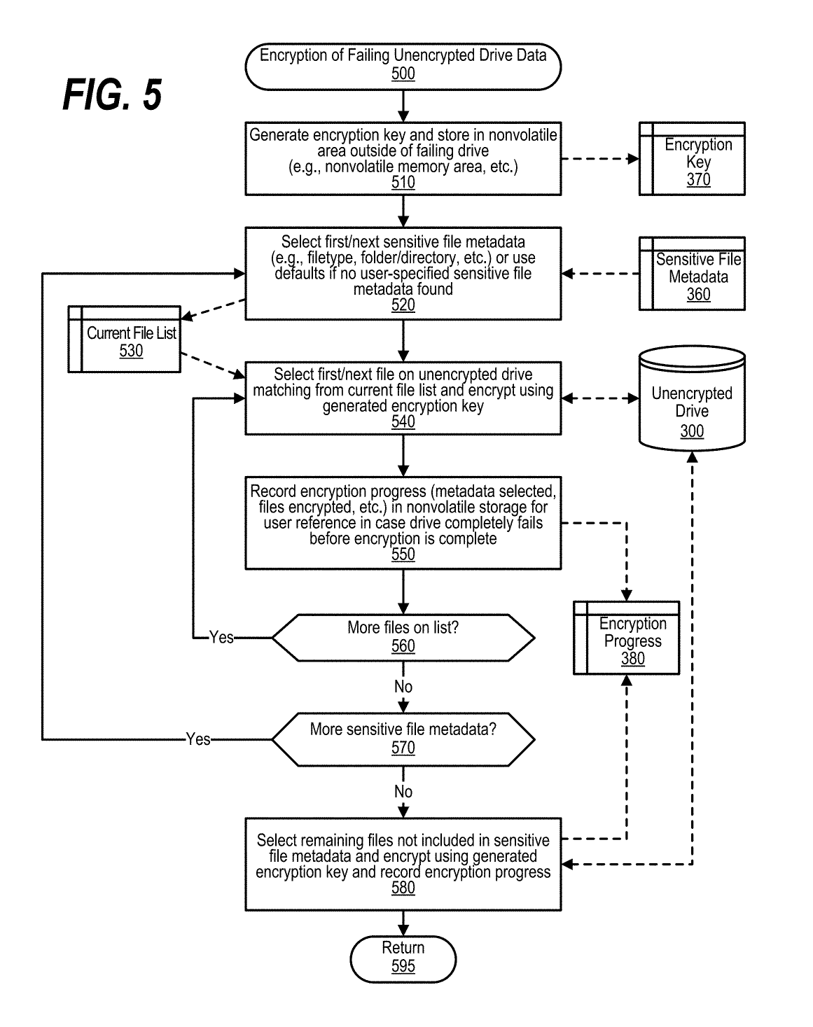

At step 460, the process informs the user that the nonvolatile storage device has started to fail and that automatic encryption of the files stored on the nonvolatile storage device is commencing. At predefined process 470, the process performs the Encryption of Failing Unencrypted Drive Data routine (see FIG. 5 and corresponding text for processing details). Predefined process 470 utilizes sensitive file metadata retrieved from data store 360 to determine the files that are stored on the nonvolatile storage device that are more likely to contain sensitive data (e.g., spreadsheets, word processing documents, files in a particular folder or directory, etc.). Predefined process generates an encryption key that is stored in data store 370 and uses the encryption key to encrypt files stored on nonvolatile storage device 300. The progress of the encryption process is tracked and written to data store 380 so that the user can ascertain which files were encrypted in the event that the nonvolatile storage device fails and becomes unusable. At step 475, the process monitors the encryption progress being performed by predefined process 470.

The process determines as to whether all of the files on the nonvolatile storage device were encrypted or whether a total drive failure occurred at the nonvolatile storage device (decision 480). If all data was encrypted before the nonvolatile storage device failed, then decision 480 branches to the ‘All data’ branch to perform step 485. On the other hand, if the nonvolatile storage device failed before all of the files were encrypted, then decision 480 branches to the ‘no’ branch to perform step 490. If all of the data has been encrypted then, at step 485, the process informs user that all of the data stored on the nonvolatile storage device has been encrypted. The user can now dispose of the nonvolatile storage device in a responsible manner and knows that if a malicious user finds the device they would be unable to access any of the data stored on the nonvolatile storage device as all of the data has been encrypted. On the other hand, if the drive failed before all of the data files were encrypted then, at step 490, the process informs user of the encryption progress with a list or description of the files that were encrypted before the nonvolatile storage device failed. In one embodiment, the process also informs the user of all of the files that were not encrypted when the drive failure occurred. The user can now determine how to dispose of the failed nonvolatile storage device in a manner that best protects the user's sensitive data. For example, in the event that sensitive files were not encrypted at the time of the drive failure, the user will likely decide to completely destroy the nonvolatile storage device to make it impossible for a malicious user to recover any files remaining on the drive. FIG. 4 processing thereafter ends at 495.

FIG. 5 is a flowchart showing steps performed to encrypt data on a previously unencrypted hard drive. FIG. 5 processing commences at 500 and shows the steps taken by a process that encrypts data on a of failing unencrypted nonvolatile storage device. At step 510, the process generates an encryption key and stores the key in a nonvolatile storage area outside of the failing nonvolatile storage device (e.g., in a nonvolatile memory area, etc.).

At step 520, the process selects the first sensitive file metadata (e.g., filetype, folder/directory, etc.). In one embodiment, the process uses default sensitive file metadata if no user-specified sensitive file metadata is found. The sensitive file metadata is retrieved from data store 360. In a further embodiment, sensitive files can be prioritized so that files that are more sensitive are encrypted before less sensitive files. For example, the user's financial records stored in a particular directory or folder may contain highly sensitive data that is encrypted before the user's correspondence directory of letters written to family and friends. The first set of files to be encrypted are written to data store 530 (e.g., list of file identifiers stored in the financials folder, etc.).

At step 540, the process selects the first file from the unencrypted nonvolatile storage device that matches the current file list and encrypts each of the files using the encryption key generated in step 510. At step 550, the process records encryption progress (metadata selected, files encrypted, etc.) in nonvolatile data store 380 for user reference in case the nonvolatile storage device completely fails before encryption of the drive is complete. The process determines as to whether there are more files in current file list 530 to select and encrypt (decision 560). If there are more files in current file list 530 to select and encrypt, then decision 560 branches to the ‘yes’ branch which loops back to step 540 to select and encrypt the next file in the list. This looping continues until all of the files in the current list have been encrypted, at which point decision 560 branches to the ‘no’ branch exiting the loop. The process determines as to whether there is more sensitive file metadata in data store 360 to select and process (decision 570). If there is more sensitive file metadata in data store 360 to select and process, then decision 570 branches to the ‘yes’ branch which loops back to step 520 to select and process the next set of sensitive file metadata that results in another current file list that is written to data store 530. This looping continues until all of the sensitive file metadata have been selected and processed, at which point decision 570 branches to the ‘no’ branch exiting the loop.

At step 580, the process selects any remaining files not included in the sensitive file metadata and encrypts these files using the generated encryption key and records the encryption progress to data store 380. When all of the files stored on the nonvolatile storage device have been encrypted, then FIG. 5 processing returns to the calling routine (see FIG. 4) at 595.

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method comprising:
detecting that an unencrypted nonvolatile storage device is starting to fail; and
in response to the detecting, encrypting one or more files stored on the nonvolatile storage device.

2. The method of claim 1 wherein the encrypting further comprising:
identifying a plurality of sensitive files stored on the nonvolatile storage device; and
encrypting the identified sensitive files.

3. The method of claim 2 further comprising:
after encrypting the identified sensitive files, encrypting a plurality of files not identified as sensitive files.

4. The method of claim 2 wherein the identification of the sensitive files further comprises:
prioritizing a sensitivity of the identified sensitive files based on a sensitive file metadata corresponding to the identified sensitive files, wherein the sensitive files with a higher sensitivity are encrypted before the sensitive files with a lower sensitivity.

5. The method of claim 1 further comprising:
tracking a progress of the encrypting of the files stored on the nonvolatile storage device;
detecting a failure of the nonvolatile storage device, wherein the failure inhibits further encryption of the files stored on the nonvolatile storage device; and
informing a user of the encryption progress, wherein the encryption progress includes a first list of the files that were encrypted prior to the failure of the nonvolatile storage device.

6. The method of claim 5 wherein the one or more files stored on the nonvolatile storage device each have a sensitivity level, wherein the progress includes the sensitivity level of the files included in the first list, and wherein the progress further includes a second list of the files that were not encrypted prior to the failure of the nonvolatile storage device and the sensitivity level of the files included in the second list.

7. The method of claim 1 further comprising:
generating an encryption key used to encrypt the files stored on the nonvolatile storage device; and
storing the encryption key in a nonvolatile storage location that does not include the nonvolatile storage device.

8. An information handling system comprising:
one or more processors;
a unencrypted nonvolatile storage device accessible by at least one of the processors that is used to store a plurality of files;
a memory coupled to at least one of the processors; and
a set of instructions stored in the memory and executable by at least one of the processors to:
detect that the unencrypted nonvolatile storage device is starting to fail; and
in response to the detection, encrypt one or more of the files stored on the nonvolatile storage device.

9. The information handling system of claim 8 wherein the encryption further comprises instructions stored in the memory and executable by at least one of the processors to:
identify a plurality of sensitive files stored on the nonvolatile storage device; and
encrypt the identified sensitive files.

10. The information handling system of claim 9 further comprising instructions stored in the memory and executable by at least one of the processors to:
after encryption of the identified sensitive files, encrypt a plurality of files not identified as sensitive files.

11. The information handling system of claim 9 wherein the identification further comprises instructions stored in the memory and executable by at least one of the processors to:
prioritize a sensitivity of the identified sensitive files based on a sensitive file metadata corresponding to the identified sensitive files, wherein the sensitive files with a higher sensitivity are encrypted before the sensitive files with a lower sensitivity.

12. The information handling system of claim 8 further comprising instructions stored in the memory and executable by at least one of the processors to:
track a progress of the encrypting of the files stored on the nonvolatile storage device;
detect a failure of the nonvolatile storage device, wherein the failure inhibits further encryption of the files stored on the nonvolatile storage device; and
inform a user of the encryption progress, wherein the encryption progress includes a first list of the files that were encrypted prior to the failure of the nonvolatile storage device.

13. The information handling system of claim 12 wherein the one or more files stored on the nonvolatile storage device each have a sensitivity level, wherein the progress includes the sensitivity level of the files included in the first list, and wherein the progress further includes a second list of the files that were not encrypted prior to the failure of the nonvolatile storage device and the sensitivity level of the files included in the second list.

14. The information handling system of claim 8 further comprising instructions stored in the memory and executable by at least one of the processors to:
generate an encryption key used to encrypt the files stored on the nonvolatile storage device; and
store the encryption key in a nonvolatile storage location that does not include the nonvolatile storage device.

15. A computer program product comprising:
a computer readable storage medium comprising a set of computer instructions, the computer instructions effective to:
detect that the unencrypted nonvolatile storage device is starting to fail; and
in response to the detection, encrypt one or more of the files stored on the nonvolatile storage device.

16. The computer program product of claim 15 wherein the encryption action further comprises actions that:
identify a plurality of sensitive files stored on the nonvolatile storage device; and
encrypt the identified sensitive files.

17. The computer program product of claim 16 wherein the actions further comprise:
after encryption of the identified sensitive files, encrypt a plurality of files not identified as sensitive files.

18. The computer program product of claim 16 wherein the identification of the sensitive files further comprises actions that:
prioritize a sensitivity of the identified sensitive files based on a sensitive file metadata corresponding to the identified sensitive files, wherein the sensitive files with a higher sensitivity are encrypted before the sensitive files with a lower sensitivity.

19. The computer program product of claim 15 wherein the actions further comprise:
track a progress of the encrypting of the files stored on the nonvolatile storage device;
detect a failure of the nonvolatile storage device, wherein the failure inhibits further encryption of the files stored on the nonvolatile storage device; and
inform a user of the encryption progress, wherein the encryption progress includes a first list of the files that were encrypted prior to the failure of the nonvolatile storage device.

20. The computer program product of claim 19 wherein the one or more files stored on the nonvolatile storage device each have a sensitivity level, wherein the progress includes the sensitivity level of the files included in the first list, and wherein the progress further includes a second list of the files that were not encrypted prior to the failure of the nonvolatile storage device and the sensitivity level of the files included in the second list.
